(19) United States
(12) Patent Application Publication
(10) Pub. No.: US 2026/0127819 A1
(43) Pub. Date: May 7, 2026

(54) DIFFUSION-GUIDED OBJECT INSERTION AND LIGHT SOURCE MANIPULATION FOR AUTONOMOUS DRIVING

(71) Applicant: NEC Laboratories America, Inc., Princeton, NJ (US)

(72) Inventors: Bingbing Zhuang, Santa Clara, CA (US); Ziyu Jiang, Sunnyvale, CA (US); Shanlin Sun, Irvine, CA (US)

(21) Appl. No.: 19/378,948

(22) Filed: Nov. 4, 2025

Related U.S. Application Data
(60) Provisional application No. 63/716,903, filed on Nov. 6, 2024.

(51) Int. Cl. G06T 17/00; G06N 3/092; G06T 15/50

(52) U.S. Cl. CPC G06T 17/00; G06N 3/092; G06T 15/506

(57) ABSTRACT

Methods and systems for training a model include generating a relightable neural radiance field (NeRF) reconstruction of an input video of a driving scene. A virtual object is inserted into the driving scene using the NeRF reconstruction to create a simulated scene. Scene intrinsics are optimized within the simulated scene. An autonomous driving model is trained using the simulated scene.

### RELATED APPLICATION INFORMATION

This application claims priority to U.S. Patent Application No. 63/716,903, filed on Nov. 6, 2024, incorporated herein by reference in its entirety.

### BACKGROUND

### Technical Field

The present invention relates to autonomous driving systems and, more particularly, to training machine learning systems for autonomous driving.

### Description of the Related Art

Autonomous driving systems may make use of machine learning systems to incorporate large amounts of information from recorded driving scenes. This training makes it possible for the autonomous driving systems to react to their present environment, analyzing information from cameras and other sensors to navigate safely.

### SUMMARY

A method for training a model includes generating a relightable neural radiance field (NeRF) reconstruction of an input video of a driving scene. A virtual object is inserted into the driving scene using the NeRF reconstruction to create a simulated scene. Scene intrinsics are optimized within the simulated scene. A model is trained for driving using the simulated scene.

A system for training a model includes a hardware processor and a memory that stores a computer program. When executed by the hardware processor, the computer program causes the hardware processor to generate a NeRF reconstruction of an input video of a driving scene, to insert a virtual object into the driving scene using the NeRF reconstruction to create a simulated scene, to optimize scene intrinsics within the simulated scene, and to train a model for driving using the simulated scene.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a simulated driving scene that includes a virtual object with controlled lighting, in accordance with an embodiment of the present invention;

FIG. 2 is a block/flow diagram of a method for training and using a model for autonomous driving, in accordance with an embodiment of the present invention;

FIG. 3 is a diagram of an autonomous vehicle that can collect video about a driving scene and automatically respond to driving conditions, in accordance with an embodiment of the present invention;

FIG. 4 is a diagram of an exemplary neural network architecture that can be used to implement part of an autonomous driving model, in accordance with an embodiment of the present invention; and

FIG. 5 is a diagram of an exemplary deep neural network architecture that can be used to implement part of an autonomous driving model, in accordance with an embodiment of the present invention.

### DETAILED DESCRIPTION OF PREFERRED EMBODIMENTS

Training a machine learning model for an autonomous driving system uses large amounts of data for both training and verification before road testing. That training data should be highly diverse to cover different possible scenarios in the real world, especially safety-critical scenarios. Collecting such data purely from real driving logs is challenging, especially for corner cases that rarely happen in real world but are important for verification.

Training data may therefore be simulated to cover scenarios where real-world training data is sparse or unavailable. A simulation pipeline may include reconstructing a digital twin of the background as a Neural Radiance Field (NeRF), then editing the digital twin to create photorealistic variations, for example including virtual object insertion and light source manipulation.

Virtual object insertion, in the context of autonomous driving, enables the simulation of new safety-critical scenarios. For example, object insertion may add a white truck driving in the wrong lane towards the autonomous vehicle, or traffic barriers sitting in the middle of the road. Light source manipulation helps to simulate data captured at different timestamps, such as from dawn to dusk, and evening. Photorealism for both virtual object insertion and light source estimation both benefit from accurate light source estimation, which, however, suffers from a high degree of ambiguity because it further relies on accurate decomposition of intrinsic scene properties such as albedo and material. The rich nature image prior offered in large diffusion models may be used to address this challenge, which enables highly photorealistic object insertion and light source manipulation. As a result, the simulated training data is more realistic and will train the autonomous driving system to provide superior results.

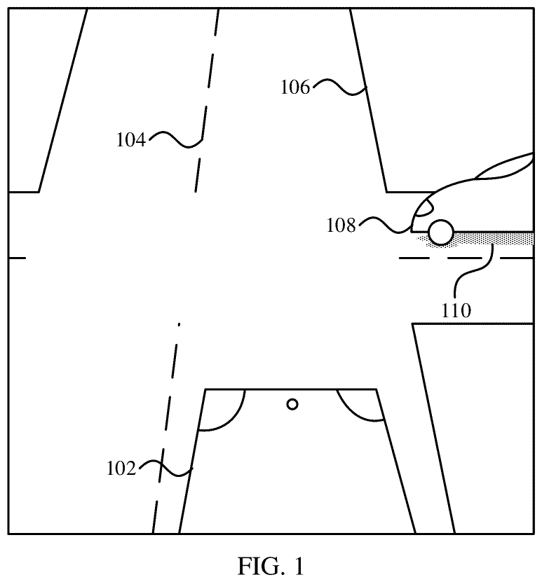

Referring now to FIG. 1, an example driving scene is shown. An initial scene may be captured by a camera that is mounted on an autonomous vehicle 102, and may show the surroundings of the autonomous vehicle 102 from a particular perspective. The illustrated view may be taken using a forward-facing dash-cam on the autonomous vehicle or using an integrated camera for a self-driving system. It should be understood that multiple such images may be used to show various perspectives, to ensure awareness of the vehicle's entire surroundings. In some cases, a panoramic or 360° camera may be used. In some cases the scene information may include depth information, such as is generated by a light detection and ranging (LiDAR) sensor. The image may be part of a series of such images making up a video, which shows how the scene evolves over time.

The scene may show a variety of objects. For example, the scene may include environmental features, such as the road boundary 106 and lane markings 104. In some embodiments, the scene may be modified to add virtual objects and to manipulate lighting. Thus, an empty driving scene may be modified to include another vehicle 108 with appropriate shadows 110. The lighting conditions of the scene may be analyzed to ensure these changes are photorealistic. Other objects, such as pedestrians, animals, road obstructions, road hazards, street lights, and barriers may also be included. A series of images of the scene may be taken together as a video to give a self-driving system within the vehicle 102 the ability to perform path prediction and vehicle control actions.

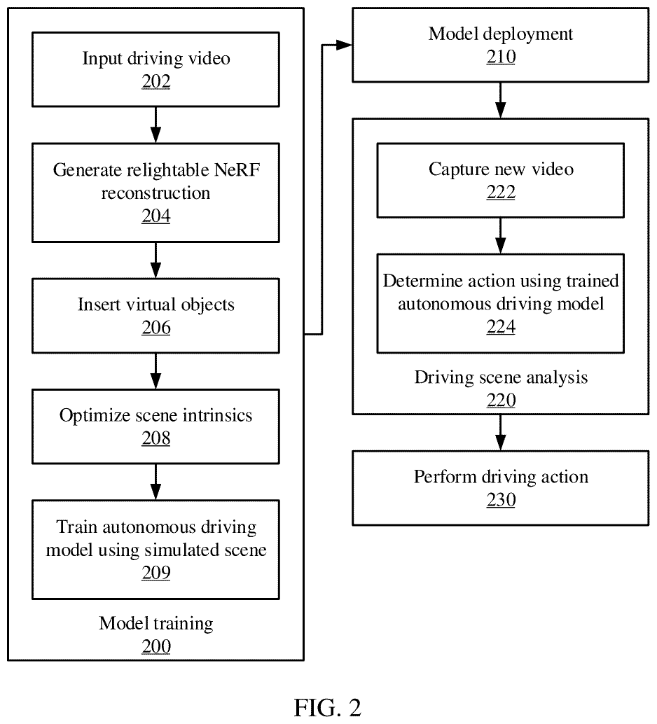

Referring now to FIG. 2, a method of generating a simulated driving scene is shown. Block 200 trains an autonomous driving model, for which block 202 receives an input video of a driving scene. The input video may include visual and optionally LiDAR data captured from sensors on a vehicle, capturing a real driving scene. The input video is analyzed in block 204 to generate a relightable NeRF reconstruction, optionally with LiDAR input as well. This reconstruction may have an associated rendering loss that comes from optimizing the relightable NeRF, for example by measuring the difference between rendered images and captured images through a pixel-wise L2 loss.

Instead of using NeRF with lighting that is fixed in the predicted RGB color at each 3D point, the albedo and material properties for each point are predicted by a machine learning model and are jointly optimized with the light source. The light source may be parameterized as sun direction and color, plus constant ambient light, for example using a sun-sky model. Sign Distance Field (SDF) is used as the geometry representation for NeRF to extract scene surfaces, as it gives surface reconstruction of higher quality than opacity. The NeRF is optimized by rendering images with the scene intrinsics and the light source, with visibility being modeled based on scene geometry and the direction of sun light to create realistic shadow. The use of albedo makes the scene relightable, with deferred rendering being performed based on the sun-sky lighting model and visibility derived from the scene surfaces. After the optimization, an initial estimate is formed of the scene intrinsics and the light source. The diffusion prior is leveraged and the light source and the scene intrinsics are further optimized.

Block 206 adds virtual objects to the driving scene. Any appropriate objects may be added as long as a three-dimensional model is available with albedo and material properties. The virtual objects may include models of real vehicles, such as computer assisted drawing (CAD) models, or artificial intelligence (AI)-generated 3D models. Other types of appropriate virtual objects may include obstructions, animals, and pedestrians. Block 206 may place the 3D vehicle models on the road surface. These 3D models may include Physically-Based Rendering (PRB) textures and materials (e.g. metalness, roughness), and can be readily inserted into the scene given the estimated light source.

After rendering, a learnable tone mapping is applied on pixels of the inserted object to match the color profile of the input video. Since there is no ground truth available to optimize the appearance of the inserted objects, the powerful nature image prior encoded in large diffusion models may be relied on to regularize the rendered images through a variational score distillation sampling (SDS) loss for the inserted virtual object(s). The optimization parameters for this loss are the light source and tone mapping. The inserted objects are used as a sort of light probe to correct the initial light source estimation, in turn improving the photorealism of the inserted objects.

For this optimization, a position may be manually specified in the scene to place the inserted object(s). Given the previously optimized lighting model, the image of the inserted object(s) can be obtained through differentiable rendering. A learnable tone mapping is applied on the object pixels to account for the effect from camera imaging. The sun-sky lighting model and the tone mapping are optimized with the rendered image using the SDS loss. The SDS loss is a function that leverages pretrained image diffusion models to measure the realism of an image. The SDS loss is differentiable and can be used to optimize the parameters that are used to render the image.

Block 208 optimizes the scene intrinsics, again with the help of diffusion priors. Specifically, the original scene may be re-rendered with the estimated intrinsics under a set of pre-defined light sources, e.g., from dawn to dusk and evening. In the absence of the ground truth image under the novel light sources, the nature image prior encoded in large diffusion models is used to regularize the rendered images through the SDS loss for the light source(s). The pre-defined set of light sources serves as hints to improve the estimated scene intrinsics. In block 204 there was an initial version of the jointly optimized scene intrinsics and lighting model. In block 206 the scene intrinsics are fixed and the lighting model is further optimized using the inserted object and the SDS loss. In block 208 the lighting model is fixed and only the scene intrinsics are optimized. To accomplish this, the scene is rendered under a set of virtual light sources and the loss is the sum of the SDS loss under each light source.

Since optimizing either of the light source or scene intrinsics alone may be under constrained, they may be optimized with all the rendering loss, the SDS loss from virtual object insertion, and the SDS loss from the light source(s). The optimization produces accurate scene intrinsics and light source estimation, with the photorealism of the inserted objects indirectly optimized as well. The light source can be manipulated, such as by changing the lighting direction or changing to a different time of the day such as from dawn to dusk.

The addition of virtual object(s) and manipulated light source(s) creates a simulated driving scene. Block 209 uses the simulated driving scene as training data for an autonomous driving model. The added virtual objects may produce driving scenes that are uncommon in practice, but which represent dangerous conditions which the autonomous driving system will need to respond to correctly. For example, block 210 may use the simulated driving scene, in combination with other simulated and real driving scenes, to perform reinforcement learning on an autonomous driving policy model. The simulated data can further be used to test autonomous driving systems, for example to determine how the model will react when a vehicle is driving in the wrong direction toward the autonomous vehicle.

The trained model is deployed 210 to a target system, for example by copying parameters of the trained model to a controller system in an autonomous vehicle. Block 220 performs scene analysis in the autonomous vehicle, for example by capturing new video from a current driving scene in block 222. The new video is used as input to the trained model in block 224, which outputs a driving action. Block 230 then performs the driving action, for example causing the autonomous vehicle to perform an acceleration, braking, and/or steering action.

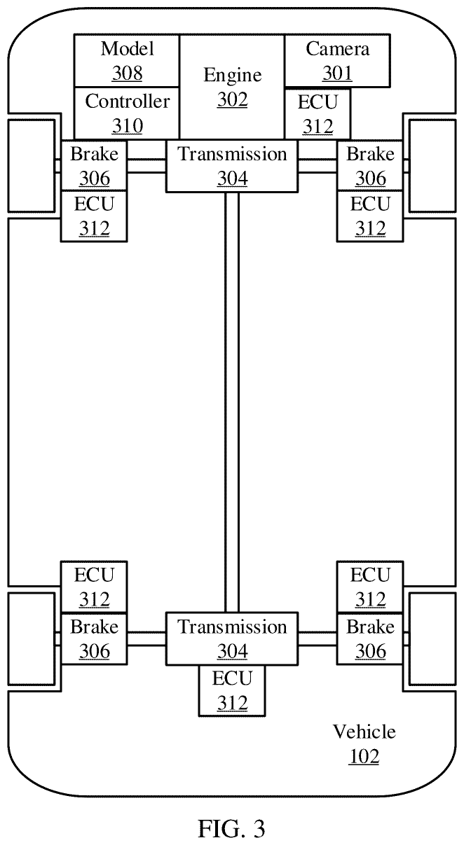

Referring now to FIG. 3, additional detail on a vehicle 102 is shown. A number of different sub-systems of the vehicle 102 are shown, including an engine 302, a transmission 304, and brakes 306. It should be understood that these sub-systems are provided for the sake of illustration, and should not be interpreted as limiting. Additional sub-systems may include user-facing systems, such as climate control, user interface, steering control, and braking control. Additional sub-systems may include systems that the user does not directly interact with, such as tire pressure monitoring, location sensing, collision detection and avoidance, and self-driving.

Each sub-system is controlled by one or more equipment control units (ECUs) 312, which perform measurements of the state of the respective sub-system. For example, ECUs 312 relating to the brakes 306 may control an amount of pressure that is applied by the brakes 306. An ECU 312 associated with the wheels may further control the direction of the wheels. The information that is gathered by the ECUs 312 is supplied to the controller 310. A camera 301 or other sensor (e.g., LiDAR or RADAR) can be used to collect information about the surrounding road scene, and such information may also be supplied to the controller 310.

Communications between ECUs 312 and the sub-systems of the vehicle 102 may be conveyed by any appropriate wired or wireless communications medium and protocol. For example, a car area network (CAN) may be used for communication. The time series information may be communicated from the ECUs 312 to the controller 310, and instructions from the controller 310 may be communicated to the respective sub-systems of the vehicle 102.

Information from the camera 301 and other sensors is provided to the model 308, which may select an appropriate action to take. The controller 310 uses the output of the model 308, based on information collected from cameras 301, to perform a driving action responsive to the present state of the scene. Because the model 308 has been trained on diverse simulated inputs, it will determine a safe and efficient path to its destination.

The controller 310 may communicate internally to the sub-systems of the vehicle 102 and the ECUs 312. Based on detected objects in the scene, the controller 310 may communicate instructions to the ECUs 312 to avoid a hazardous condition. For example, the controller 310 may automatically trigger the brakes 306 to slow down the vehicle 102 and may furthermore provide steering information to the wheels to cause the vehicle 102 to move around a hazard.

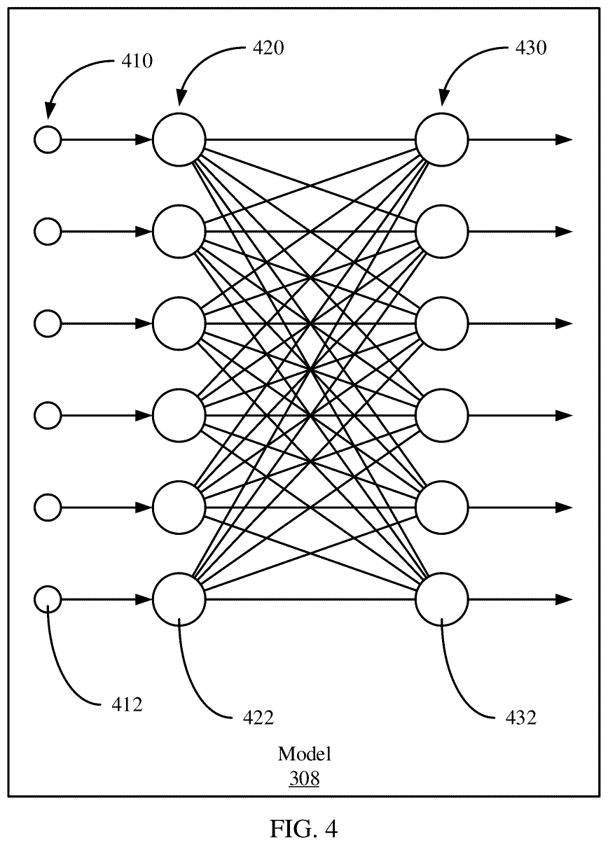

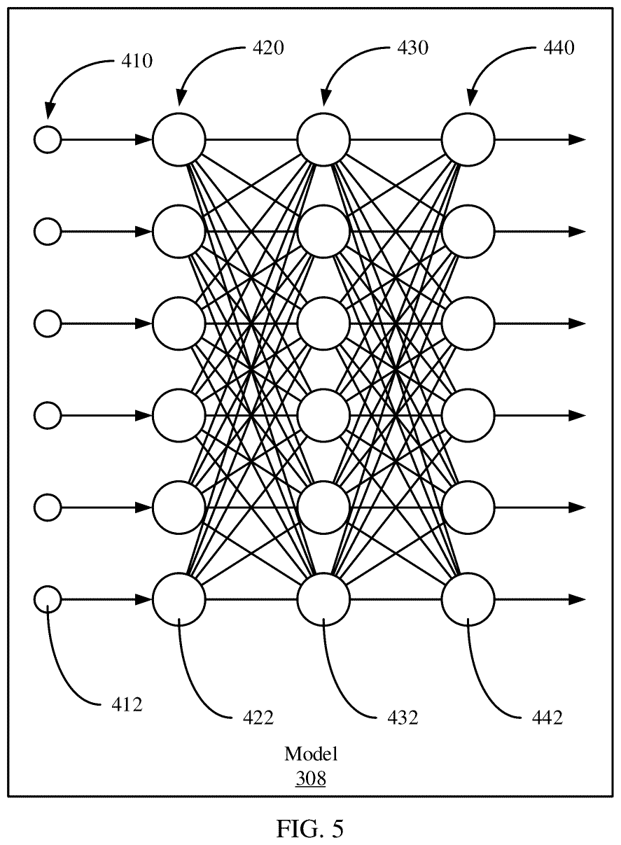

Referring now to FIGS. 4 and 5, exemplary neural network architectures are shown, which may be used to implement parts of the present machine learning models, such as the model 308. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 420 of source nodes 422, and a single computation layer 430 having one or more computation nodes 432 that also act as output nodes, where there is a single computation node 432 for each possible category into which the input example could be classified. An input layer 420 can have a number of source nodes 422 equal to the number of data values 412 in the input data 410. The data values 412 in the input data 410 can be represented as a column vector. Each computation node 432 in the computation layer 430 generates a linear combination of weighted values from the input data 410 fed into input nodes 420, and applies a non-linear activation function that is differentiable to the sum. The exemplary simple neural network can perform classification on linearly separable examples (e.g., patterns).

A deep neural network, such as a multilayer perceptron, can have an input layer 420 of source nodes 422, one or more computation layer(s) 430 having one or more computation nodes 432, and an output layer 440, where there is a single output node 442 for each possible category into which the input example could be classified. An input layer 420 can have a number of source nodes 422 equal to the number of data values 412 in the input data 410. The computation nodes 432 in the computation layer(s) 430 can also be referred to as hidden layers, because they are between the source nodes 422 and output node(s) 442 and are not directly observed. Each node 432, 442 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 432 in the one or more computation (hidden) layer(s) 430 perform a nonlinear transformation on the input data 412 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a model, comprising:
generating a relightable neural radiance field (NeRF) reconstruction of an input video of a driving scene;
inserting a virtual object into the driving scene using the NeRF reconstruction to create a simulated scene;
optimizing scene intrinsics within the simulated scene; and
training a model for driving using the simulated scene.

2. The method of claim 1, wherein generating the relightable NeRF reconstruction includes predicting albedo and material properties using a machine learning model, jointly optimized with a light source.

3. The method of claim 1, wherein optimizing the scene intrinsics includes optimizing a loss function that includes a score distillation sampling (SDS) loss from light source manipulation, an SDS loss from inserting the virtual object, and a rendering loss from the NeRF reconstruction.

4. The method of claim 1, wherein generating the NeRF reconstruction includes a sign distance field (SDF) geometry representation of the input video.

5. The method of claim 1, wherein inserting the virtual object includes tone matching to match a color profile of the input video.

6. The method of claim 1, wherein the virtual object includes information about physically-based rendering textures and materials.

7. The method of claim 1, further comprising manipulating a light source in the simulated scene to change a direction and/or a time of day.

8. The method of claim 1, wherein training the autonomous driving model includes performing reinforcement learning on a neural network model using the simulated scene and a plurality of additional driving scenes.

9. The method of claim 1, further comprising analyzing a new video using the autonomous driving model to determine a driving action and performing the driving action in an autonomous vehicle.

10. The method of claim 9, wherein the driving action is selected from the group consisting of acceleration, braking, and steering.

11. A system for training a model, comprising:
a hardware processor; and
a memory that stores a computer program which, when executed by the hardware processor, causes the hardware processor to:
generate a relightable neural radiance field (NeRF) reconstruction of an input video of a driving scene;
insert a virtual object into the driving scene using the NeRF reconstruction to create a simulated scene;
optimize scene intrinsics within the simulated scene; and
train a model for driving using the simulated scene.

12. The system of claim 11, wherein generation of the relightable NeRF reconstruction includes prediction of albedo and material properties using a machine learning model, jointly optimized with a light source.

13. The system of claim 11, wherein optimization of the scene intrinsics includes optimization of a loss function that includes a score distillation sampling (SDS) loss from light source manipulation, an SDS loss from inserting the virtual object, and a rendering loss from the NeRF reconstruction.

14. The system of claim 11, wherein generation of the NeRF reconstruction includes a sign distance field (SDF) geometry representation of the input video.

15. The system of claim 11, wherein insertion of the virtual object includes tone matching to match a color profile of the input video.

16. The system of claim 11, wherein the virtual object includes information about physically-based rendering textures and materials.

17. The system of claim 11, wherein the computer program further causes the hardware processor to manipulate a light source in the simulated scene to change a direction and/or a time of day.

18. The system of claim 11, wherein training of the autonomous driving model includes reinforcement learning on a neural network model using the simulated scene and a plurality of additional driving scenes.

19. The system of claim 11, wherein the computer program further causes the hardware processor to analyze a new video using the autonomous driving model to determine a driving action and to perform the driving action in an autonomous vehicle.

20. The system of claim 19, wherein the driving action is selected from the group consisting of acceleration, braking, and steering.
